(19) United States
(12) Patent Application Publication
(10) Pub. No.: US 2008/0177628 A1
(43) Pub. Date: Jul. 24, 2008

(54) Method for transmitting cash register information by the internet

(76) Inventor: Raymond Payette, Quebec (CA)

Correspondence Address: RAYMOND PAYETTE, 3475 VAUTELET # 306, QUEBEC, QC, G1W 4V9, omitted

(21) Appl. No.: 11/801,430

(22) Filed: May 10, 2007

Related U.S. Application Data
(63) Continuation-in-part of application No. 11/656,201, filed on Jan. 23, 2007.

(51) Int. Cl. G06Q 30/00; G06Q 20/00

(52) U.S. Cl. 705/14; 705/23

(57) ABSTRACT

The problem with Point of Sale (POS) receipts is that the information is “dead” because it is only printed. A solution is to send it to the customer by the Internet allowing it to remain in a digital format. A system and a method for transmitting by the Internet cash register information to a customer. The cash register looks up the customer's digital record, updates it with the current sales, selects an appropriate protocol, attaches additional information and sends the current sales information with the additional information to the customer's Internet address. All the sales information is processed in a repeating fashion. Furthermore handling of coupons is costly. In one embodiment sales receipts contain rebates, allowing them to be later redeemed digitally. In a further embodiment the rebates are personalized by using content-based and collaborative-based technology.

The present application relates to prior patent application filed with Ser. No. 11/656,201 on Jan. 23, 2007 and U.S. Ser. No. 11/801,430. It corrected clerical errors made on lines 94, 95, 141, 169, 188, 225, 245, 263, 264 and 265.

### TECHNICAL FIELD

The present invention relates generally to cash registers, and more particularly to a system and a method for transmitting digital sales information by the Internet to a customer.

### BACKGROUND OF THE INVENTION

Electronic sales are done completely digitally; the customer usually sends an email to the seller who prepares a digital order, then a digital shipping notice and a digital receipt that he sends to the customer. The seller may inform the customer of various promotions.

Store sales are generally recorded by cash registers that accumulate information on current sales and on daily sales. Frequently these cash registers are interconnected by a local area network (LAN) to a server. Often a customer has a record in a database that can be accessed by the server. Usually the seller retains digital information that can be analyzed to maintain adequate stock levels and to study consumers' behaviors. Shoppers who buy products or services are usually handed a printed receipt of what they bought, the prices of each purchase and their total, the tax paid and the date and time of the purchase. If the consumer wants to make any calculation he needs to do it mentally or he has to input the information in a computer or a calculator; the information is “dead” until it is transformed into a digital form. It would be very beneficial to willing customers to obtain the digital information without having to re-enter it because it would save time and prevent errors.

Currently in addition to sales and claimed rebates, sales receipts sometimes contain messages, the merchant's Web address, his logo, advertising, sales conditions, opening hours, coalition points status, a lottery, greetings and surveys.

Additional information such as the nutritional components of alimentary goods, recipes, conservation precautions or promotions and discounts tailored on the customer's habits could be added to the digital information; the seller would benefit from this economical form of advertising and the customer would obtain enriched information in a digital way that could help him better manage his purchases.

Merchants use different retention marketing means to gain customers loyalty. One way is to use coupons. By definition a coupon is a physical certificate that requires manipulation both by the customer and the cashier, so this is a costly and inefficient method. Another way is to issue a validation code, such as in Leason and al. U.S. Pat. Appl. No. 2007043620; it requires that the customer have it at the POS and that can cause problems because he might have forgotten it, left it at home . . . . Nguyen, U.S. Pat. Appl. No. 2003036957 avoids the use of discount coupons by using a discount payment clearinghouse that will add costs and delays.

Merchants want customers to become loyal to the store (physical or virtual) whereas manufacturers (or external companies) want customers to become loyal to the manufacturer's brands or products. Both may issue rebates. Manufacturers' rebate are not personalized, they are apt to benefit anyone purchasing the product. The present invention only covers merchant rebates whereas Algiene, U.S. Pat. Appl. No. 20030209540 covers manufacturers' rebates that the merchant has to honor by obtaining redemption and reimbursement information in order to reconcile the systems. Another way to treat manufacturers' rebate is claimed in Quinlan and al. U.S. Pat. Appl. No. 20040215514 where the rebate is treated “at a time subsequent to the purchase”; this involves a supplementary action by the consumer that is time consuming and does not permit the customer's immediate gratification at the POS. Quinlan and al. U.S. Pat. Appl. No. 20020161641 requires that the manufacturer's rebate request be sent by email; this is a supplementary step not conducive to customers' immediate gratification. Hadjigeorgis, U.S. Pat. Appl. No. 20020152118 uses a third-party agency that involves supplementary costs and delays.

Scroggie and al. U.S. Pat. Appl. No. 20020120496 has claims pertaining to the distribution of incentives to retail customers, whereas the present invention not only distributes incentives but it allows them to be managed continuously in a digital fashion, never having to be typed-in because the sales information that includes the offered rebates and their redemption is sent back digitally to the customer. Not only are the rebates transmitted to the customers via the Internet, but also their usage at POS. This link is essential to keep the information live, especially when the rebates span over the period of many sales and when they are redeemed gradually.

Merchants strive to have a competitive advantage over their competitors. They use customer relationship management software that allows tracking and analyzing of each customer's profile, preferences, activities and complaints. There is a need for merchants to issue personalized rebates that are tailor-made for each customer. The customer wants to be treated as someone special and he appreciates being offered a rebate that caters to his profile, preferences and habits, for example he will appreciate rebates that have filtered out incentives that a customer will not be interested in, such as coupons for meat to a vegetarian.

On the other hand the merchant wants to offer a rebate that will result in an increase of his profit, so he must be careful in awarding it. Optimizing profits from rebates requires sophisticated consumer behavior analysis that can best be done by computer.

There are many computer systems that use content-based and collaboration-based technologies that are used to recommend books such as Linden and al. U.S. Pat. No. 6,266,649 or Web links as witness by IBM's article Web site personalization, Willy Chiu:

http://www-128.ibm.com/developerworks/websphere/librarY/techarticles/hipods/personalize.html

There are many algorithms such as the Personalized Recommender System Robin van Meteren and Maarten van Someren:

http://www.ics.forth.gr/˜potamias/mlnia/paper_{—}6.pdf

### SIFT:

http://hcil.cs.umd.edu/trs/96-10/node7.html

### and JRank:

http://www.aicml.cs.ualberta.ca/_banff04/icml/pages/papers/221.pdf

This technology is evolving as testified by An intelligent adaptive news filtering system, Ying Huang:

http://www.renci.org/ublications/theses/YHuangThesis.pdf

### and A Frameworkfor Collaborative, Content-Based and Demographics Filtering, Michael J.Pazanni:

http://www.ics.uci.edu/˜pazzani/Publications/AIREVIEW.pdf

These technologies can be applied to rebate selection.

### SUMMARY OF THE INVENTION

It is an object of this invention to provide a system for storing cash register sales in a digital form, to associate them with a customer and to transmit it to him via the Internet.

It is an object of this invention to provide a system for storing cash register sales in a digital form, to associate them with a customer, to add additional digital information that can be useful to the customer or the seller and to transmit it to him via the Internet.

It is also an objective of this invention for storing rebates offers in a digital form, of informing the customer of these offers by the Internet, of matching the sales with the offers digitally at sales time.

It is another object of this invention to provide a method for sending via the Internet information from a cash register to a customer comprising the steps of storing cash register sales in a digital form, associating them with a customer record, adding additional digital information that can be useful to the customer or the seller and transmitting this enriched information to the customer via the Internet.

In accordance with an exemplary embodiment of the present invention, a customer purchases goods or services from a seller who records the transaction with a cash register. The seller requires identification information that can include the customer's phone number for example. That information is matched to the customer's record already recorded that typically contains his phone number, his name and home address, his email address and may include some of the customer's preferences. The means of identification could involve the use of smart cards. The current sale is then added to the customer's record. If the customer's preferences allow it, additional information is attached to the current sales' information and they are sent to the customer via the Internet according to the agreed protocol. This protocol may use current email protocol such as a POP3, HTRP, FTP or other . . . .

This method can be used to record deposits or down payments for future delivery. The essence of this method is that there must be a link between the cash register and the Internet in order to retain digital information in a digital format.

It must be emphasized that this is not a payment method, though means of payments may be sent according to the customer's preferences.

A customer may obtain his personal information including his profile, sales and rebates history, by accessing the Web. This can be done by E-mail if he so chooses or it can be posted in the merchant's Web site. A customer may access this by logging his account with an ID and a password. This might be done with a portable device, but it can also be available from a kiosk that the merchant might have in his store in which case the merchant might want to dedicate the browser to his Web site.

In another preferred embodiment, the additional information contains rebates applicable on future purchases. When redeemed by the customer during a sale, the merchant checks the customer's identity by demanding ID papers, a smart card or simply by asking for some personal question such as the customer's phone number. If the customer isn't registered he will not have any personalized offers and the system ends. If he is registered and the sale corresponds to the offered rebate as recorded in his previous sale, such as a 2 for 1 offer with a quantity limit of 3 items, then the rebate will be awarded. The system will then make an analysis and it will select rebates offers. The system may choose not to make any rebate offer, at which point the process ends. If rebates offers are made, they are recorded in a database, printed on the sales receipt and sent by Internet either by E-mail or posted on the Web for the customer's access. Such information will then be available from a kiosk or from portable devices such as an Internet linked phone.

In another preferred embodiment, the merchant uses a multi-user computer system that has a database of items he sells that is designed to select personalized sales rebates. This system produces a mapping of the items and associates products such as coffee with coffee filters or trousers with belts; the system also groups items such as men's clothing, outdoor clothing, summer clothing and trousers. The system stores the customer's profile, his preferences and demographics. It also stores popular items as determined by sales analysis and by sales group analysis such as single males between the ages of 20 to 35. Another way to recognize popular items is to take stock of current ad campaigns and current trends such as obesity awareness. The system also maps the customer's shopping record to determine his purchase habits, such as buying a small bag of coffee every two weeks. It analyses the customer's Internet behavior, such as reading healthy recipes. The system applies business rules, for example selecting sex biased products such as shaving cream for all male households. The system also stores the merchant's assumptions; for example he might ward off the so-called “cherry-pickers” who only buy bargains; the merchant's strategy might be to offer him rebates for luxury goods that is aimed at frustrating the customer. He may utilize some algorithms that weight several factors; this relates to the evolving content-based and the collaborative-based methods technologies. These personalized rebates are then transmitted to the customer by the Internet.

### BRIEF DESCRIPTION OF THE DRAWING

FIG. 1 is a flowchart of a method illustrating the Internet transmission of a cash register sale.

FIG. 2 is an illustration depicting the present point of sale (POS) process.

FIG. 3 is an illustration depicting the point of sales (POS) process taking into account the Internet communications covered by the present invention.

FIG. 4 is a flowchart illustrating the initial registration method.

FIG. 5 is a flowchart illustrating the merchant's system for transmitting cash register digital rebates by the Internet

FIG. 6 is a flowchart of a method describing the merchant's database inputs and output.

### DETAILED DESCRIPTION

In an exemplary embodiment of the present invention, cash registers are interconnected to a local area network (LAN) and to a server. Some databases including the products' database and the customers' database are also connected to the server. When a sale is recorded details are retrieved from the products' database to complete the invoice and when the sale is completed the invoice is added to the customer's record; most frequently only the total sales are recorded. Total sales, taxes perceived, shipping information and credit information are also recorded for administrative purposes.

The present invention consist of adding supplemental information such as nutritional values, guarantees, instructions, warnings, links to suppliers, promotions and publicity to the current invoice as requested by the instructions of the customer that are found in his record. This enriched invoice is then sent to the customer using Internet according to a protocol agreed upon and specified in the customer's file, such as HTTP, FTP, POP3 . . . .

Rebates are issued immediately at POS, to entice the customer to return as quickly as possible. This has the added benefit of continuously offering fresh rebates to the customers and unlike present practice it avoids stale incentives that are past incentives that retain little interest from the customer.

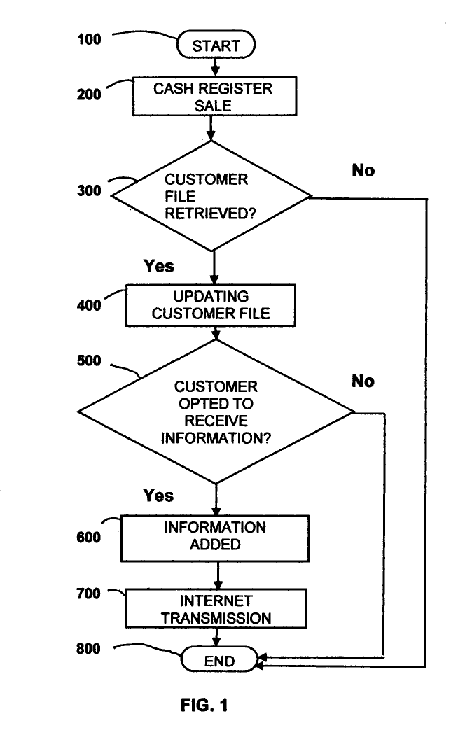

FIG. 1 is a flowchart of a method for transmitting cash register information by the Internet. The method starts at 100 when a cash sale is about to be recorded. At step 200 the sales items are recorded in the cash register. At step 300 there is an attempt to retrieve the customer's record. If the record is not retrieved, the process ends at step 800. If the record is retrieved, the record is updated with the current sale at step 400. If the customer did not opt to receive information by the Internet 500, flow ends at step 800. Additional information enriches the customer's record at step 600. Then at step 700, using an Internet protocol, enriched information is sent to the customer. The flow then stops at step 800.

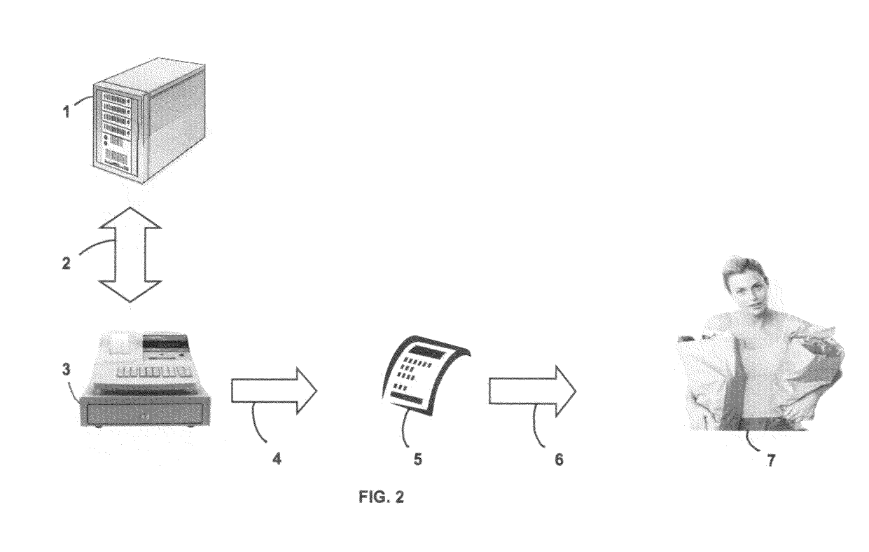

FIG. 2 is an illustration depicting the present point of sale process where there are communication exchanges 2 between the supplier's computer 1 and his cash register 3 that produces 4 a sales receipt 5 that is handed 6 to the customer 7.

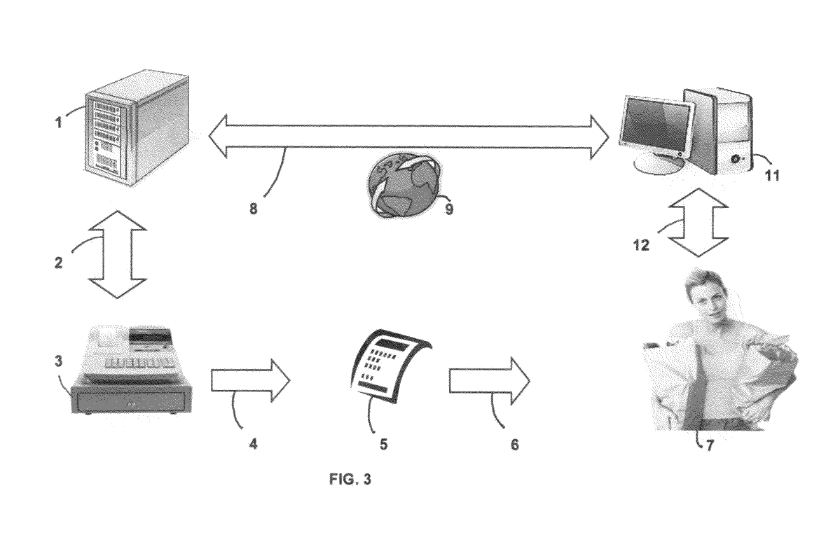

FIG. 3 is an illustration depicting the point of sale process where there are communication exchanges 2 between the supplier's computer 1 and his cash register 3 that produces 4 a sales receipt 5 that is handed 6 to the customer 7 who can exchange information 12 with his computer 11 that exchanges information 8 through Internet 9 with the supplier's computer 1. As can be appreciated the invention involves interaction between the customer's computer and the Internet. It also provides a concrete, tangible and observable means for the customer to interact with the supplier's system after the sale has been completed by answering his queries and by providing additional reports and information he may desire.

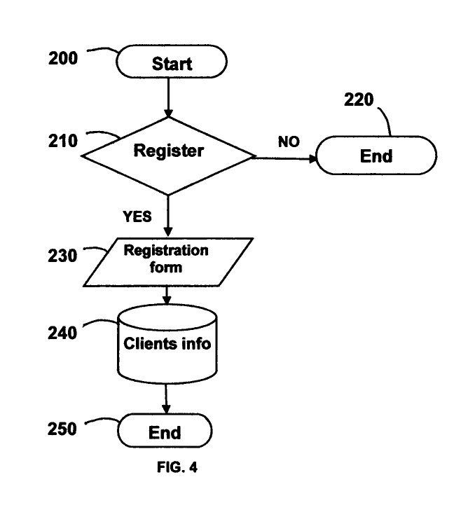

FIG. 4 is a flowchart illustrating the initial registration method that starts at 205. The customer decides to register 210, if he does not, the method ends 220, else he completes a form 230 that may be in digital format. The information is then stored in a computer system network 240 that ends this method 250.

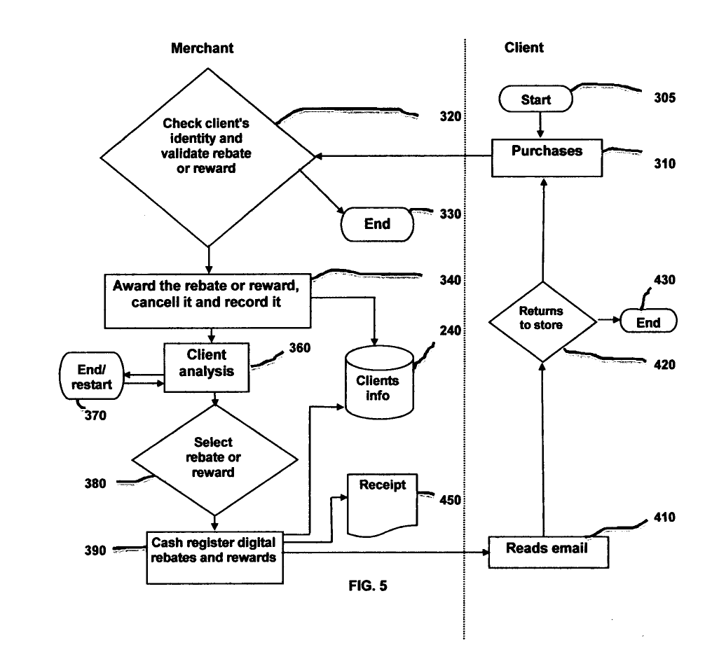

FIG. 5 is a flowchart divided in two groups, one representing the merchant's actions and the other the customer's. It illustrates the system for transmitting cash register digital rebates by the Internet that starts at step 305 when the customer makes a purchase 310 and after checking the customer's identity the merchant decides if it is valid 320; if it isn't the process stops 330, else the merchant awards the rebate 340 and records it in the computer system network 240. The merchant analyses the customer's profile 360 at which point he may decide to stop the process 370 if he believes that awarding rebates to this customer is not profitable. If he decides to continue offering rebates, though the customer has not purchased anything, he will start from here 370 and proceed making an analysis 360. After that step the merchant selects a rebate to offer to the customer 380 and the cash register digital rebates will be issued 390 and recorded in the computer system network 240, he will emit a receipt 450 to the customer and he will send an email and/or update a Web site that the customer will access 410. The customer will then decide 420 whether to end the process 430 or make another purchase 310.

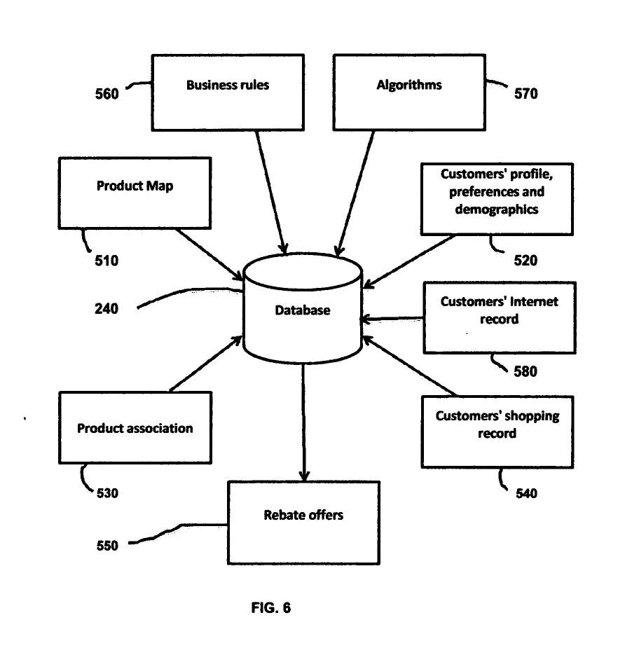

FIG. 6 is a flowchart of a method describing the merchant's database inputs and output that stores a product map 510, the customers' profile, preferences and demographics 520, the identification of product associations 530, the customers' shopping record 540, the customer's Internet record 580 and with the use of business rules 560 and content-based and collaboration-based algorithms 570, produce personalized rebate offers 550.

In compliance with the statute, the invention has been described in a language more or less specific as to structure and methods features. It is to be understood, however, that the invention is not limited to the specific features described, since the means herein disclosed comprise exemplary forms of putting the invention into effect. The invention is, therefore, claimed in any of its forms or modifications within the proper scope of the appended claims appropriately interpreted in accordance with the doctrine of equivalents and their applicable judicial doctrines. For example the cash register 100 and the computer 300 may be combined into a single unit.

Having described my invention, what I claim as new and desire to secure by Letters Patents is:

1) A system for transmitting cash register digital sales information by the Internet where the customer's record is selected, digital sales information is temporarily stored, the customer's record is updated, an Internet protocol is selected, and the current sales are transmitted to the customer by the Internet using the selected protocol.

2) A system as recited in claim 1, where additional digital information is added to enrich the information and it is sent to the customer.

3) A method for transmitting cash register sales information by the Internet comprising the steps of: digitally gathering sales information, matching the customer to his digital record, selecting an Internet protocol, adding additional information to enrich the customer's shopping experience, sending by the selected Internet protocol the enriched information to the customer.

4) The system as in claim 1 where the cash register digital sales information also contains rebates offers.

5) The system as in claim 4 wherein previously issued rebates are digitally validated at the POS when redeemed.

6) The system as in claim 1 wherein the cash register digital sales information is E-mailed to the customer.

7) The system as in claim 1 wherein the cash register digital sales information is transmitted to a Web site that can be accessed by each customer after logging in.

8) A merchant's system for transmitting cash register digital information by the Internet that includes rebates comprising the steps of:
a. Initially, digitally registering a customer's profile including demographics and preferences in a distributed computer network;
b. Digitally validating the customer's identity at POS;
c. At POS awarding the customer's claimed rebates, digitally recording them and digitally cancelling them from further use;
d. Digitally analyzing the customer's profile and sales information;
e. Digitally selecting rebates for the customer;
f. Awarding the customer's future rebates and digitally recording them, digitally preparing the customer's receipt with the cash register digital sales information, including digital rebates redemptions and offers and transmitting it to the customer by the Internet;
Step 6) b. to step 6) f. are repeated.

9) The method as in claim 3 wherein the merchant uses a multi-user computer system that has a database of items used to offer rebates to a customer further comprises the computer-implemented steps of:
a. generating a non-customer-specific data structure which maps individual items of the database including their content and properties and identifying popular items that are part of a trend or that are being promoted in the medias;
b. identifying sets of associated items in which the associations are based on their nature and functionalities;
c. identifying the customer's profile and preferences;
d. mapping the customer's shopping habits with his sales record to reveal what he is likely to buy and when;
e. recording and analyzing the customer's Internet navigation habits;
f. using the previously gathered information and using an assumption grid and association algorithms, filtering out items that are not likely to be of interest to the customer and selecting items that are likely to be inciting to him;
g. using the selection in f. to choose a set that is likely to be profitable and to make an offer of rebates to the customer that is also transmitted to him by the Internet.

10) The method as in claim 9 where steps a. to f. are made off-line.
